(19) United States
(12) Patent Application Publication
(10) Pub. No.: US 2026/0285258 A1
(43) Pub. Date: Sep. 24, 2026

(54) ADAPTER FOR WINDSCREEN-WIPER BLADE AND WIPING DEVICE

(71) Applicant: VALEO SYSTEMES D'ESSUYAGE, La Verriere (FR)

(72) Inventors: Vincent GAUCHER, La Verriere (FR); Jerome JEANPIERRE, La Verriere (FR)

(73) Assignee: VALEO SYSTEMES D'ESSUYAGE, La Verriere (FR)

(21) Appl. No.: 19/479,399

(22) PCT Filed: Apr. 25, 2024
(86) PCT No.: PCT/EP2024/061355

§ 371 Date: Oct. 28, 2025

(30) Foreign Application Priority Data
Apr. 28, 2023 (FR) 2304356

(51) Int. Cl. B60S 1/40

(52) U.S. Cl. CPC B60S 1/4087

(57) ABSTRACT

An adapter that is configured to be able to join together a windscreen-wiper blade and a windscreen-wiper arm. The adapter includes a locking device having a flexible tab supporting a locking lug configured to be inserted into a corresponding opening in the windscreen-wiper arm in order to lock the longitudinal movement of the arm. The flexible tab extends in a transverse direction, one end of the flexible tab being connected to the side wall and the other end supporting an unlocking button accessible from one side of the adapter opposite to the side wall, the flexible tab being pivotable about a longitudinal pivot axis in order to disengage the locking lug from the windscreen-wiper arm.

### TECHNICAL FIELD

The present invention relates to an adapter for a windshield wiper configured to be able to join a windshield wiper to a wiper arm intended to be connected to a motorized wiper mechanism of a vehicle. A further subject of the invention is a wiper device comprising a wiper arm and a windshield wiper connected to said arm by means of said adapter.

### BACKGROUND OF THE INVENTION

Motor vehicles are commonly provided with wiper systems intended for cleaning the glazed surfaces, and in particular the windshields, thereof. Such wiper systems comprise a wiper arm and a windshield wiper driven by said arm. The wiper arm is connected to an electric motor of the vehicle and the windshield wiper comprises at least one wiper blade designed to come into contact with the glazed surface to be wiped. In order to be able to drive the windshield wiper, an adapter is arranged between the wiper arm and a connector of the wiper.

There are various kinds of arms, such as hook arms, arms with a lateral pivot axis, arms with longitudinal clip-fastening, rod arms, etc.

An adapter is thus specifically configured to cooperate with a rod arm, the rod arm being slid into a housing in the adapter in a longitudinal direction. Rod arms are flat and have the advantage of being compact as a result of their small thickness.

The rod arm is locked in the adapter thanks to, in particular, a locking means formed by a lug borne by a longitudinal tongue mounted so as to be able to pivot by elastic bending about a transverse pivot axis while the arm is being introduced into the adapter. When the arm is in place in the adapter, the flexible tongue is returned into its initial position such that the locking lug fits in an opening formed in the drive arm, thereby immobilizing the arm in the longitudinal introduction direction.

The tongue is connected to two push buttons formed in the opposite rear flanks of the adapter. To disengage the locking lug from the arm, the user simultaneously presses the push buttons of the adapter so as to pivot the tongue about the transverse pivot axis and thus to disengage the locking lug from the drive arm.

However, the improvement in the aerodynamics of the spoilers of windshield wipers makes this adapter locking means incompatible with the most recent versions of wipers, the push buttons colliding with the rear spoiler.

### SUMMARY OF THE INVENTION

One of the aims of the present invention is to provide an adapter that at least partially solves a drawback of the prior art.

To this end, one subject of the invention is an adapter configured to be able to join a windshield wiper to a wiper arm, the adapter comprising:
a side wall and an upper surface that surmounts the side wall and extends as far as a flank of the adapter on the opposite side to the side wall,
an arm housing that extends in a longitudinal direction at the back of the upper surface and is configured to receive one end of the wiper arm,
a locking device that has a flexible tab bearing a locking lug configured to be inserted into a corresponding opening in the wiper arm in order to lock the longitudinal movement of said arm,
   characterized in that the flexible tab extends in a transverse direction, one end of the flexible tab being connected to the lateral wall and the other end bearing an unlocking button that is accessible from an opposite side of the adapter to the side wall, the flexible tab being able to pivot about a longitudinal pivot axis in order to disengage the locking lug from the wiper arm.

The adapter is particularly suitable for connection to a wiper, the spoiler of which has an aerodynamic shape that rises higher in the adapter than the spoilers of prior art wipers, the actuation of the locking device on the side of the adapter making it compatible with these versions of spoilers and with a sufficient clearance. In addition, the locking device is easy to produce and easy to actuate.

The adapter may also have one or more of the features that are described below, taken alone or in combination.

The side wall and the flank of the adapter each have a free end and an end connected to the upper wall. Thus, the flank of the adapter and the side wall form the opposite sides of the adapter and face one another.

The unlocking button may be formed by a cutout of the upper surface in the flank.

The flexible tab extends in a transverse direction (with respect to the longitudinal direction) from the side wall toward the flank of the adapter. In other words, the end of the flexible tab is directly connected to the side wall and the other end of the flexible tab bearing the unlocking button is accessible from the flank of the adapter.

The locking lug borne by the flexible tab is situated between the two ends of the flexible tab. In other words, the locking lug borne by the flexible tab is situated between a portion of the side wall of the adapter from which the flexible tab extends and the unlocking button.

The flexible tab pivots, by elastic bending, about the longitudinal pivot axis, formed at a hinge linking the flexible tab to the side wall, into an unlocking position for disengaging the locking lug from the wiper arm.

The flexible tab may be configured to be able to pivot through an angle greater than 20° and/or through an angle less than 45°.

The flexible tab may have reinforcing brackets arranged under the end connected to the unlocking button.

The locking lug may have a transverse thickness that increases in the direction in which the wiper arm is introduced into the arm housing, so as to cause the flexible tab to gradually pivot as said arm is introduced.

The locking device is, for example, arranged at the rear of the arm housing.

The upper surface has, for example, a smooth and curved shape, a cross section of which is substantially S-shaped.

The adapter comprises, for example, two cylindrical studs that face one another and are configured to engage with respective circular orifices in a connector of the windshield wiper, the cylindrical studs being formed at the end of parallel and opposite tongues that are connected to the back of the upper wall and extend on either side of the arm housing.

A further subject of the invention is a wiper device comprising a wiper arm, in particular a rod arm, and a windshield wiper, characterized in that it comprises an adapter as described above for connecting the windshield wiper to the end of the wiper arm.

### BRIEF DESCRIPTION OF DRAWINGS

Other advantages and features will become apparent on studying the following description of a particular, but in no way limiting, embodiment of the invention, and the appended drawings, in which:

FIG. 1 is a perspective view of a wiper device.

FIG. 2 is a perspective view of one end of a wiper arm of the wiper device.

FIG. 3 is a perspective view of one end of the wiper arm inserted into an adapter of the wiper device in FIG. 1.

FIG. 4 is a perspective view of the adapter.

FIG. 5 is a bottom view of the adapter in FIG. 4.

FIG. 6 is a view of the front side of the adapter in FIG. 4.

FIG. 7 is a rear view of the adapter in FIG. 4.

In these figures, identical elements bear the same reference numerals.

### DETAILED DESCRIPTION OF THE INVENTION

The following embodiments are examples. Although the description refers to one or more embodiments, this does not necessarily mean that each reference relates to the same embodiment, or that the features only apply to one embodiment. Individual features of different embodiments may also be combined or interchanged to provide other embodiments without departing from the scope of the invention, as defined by the claims.

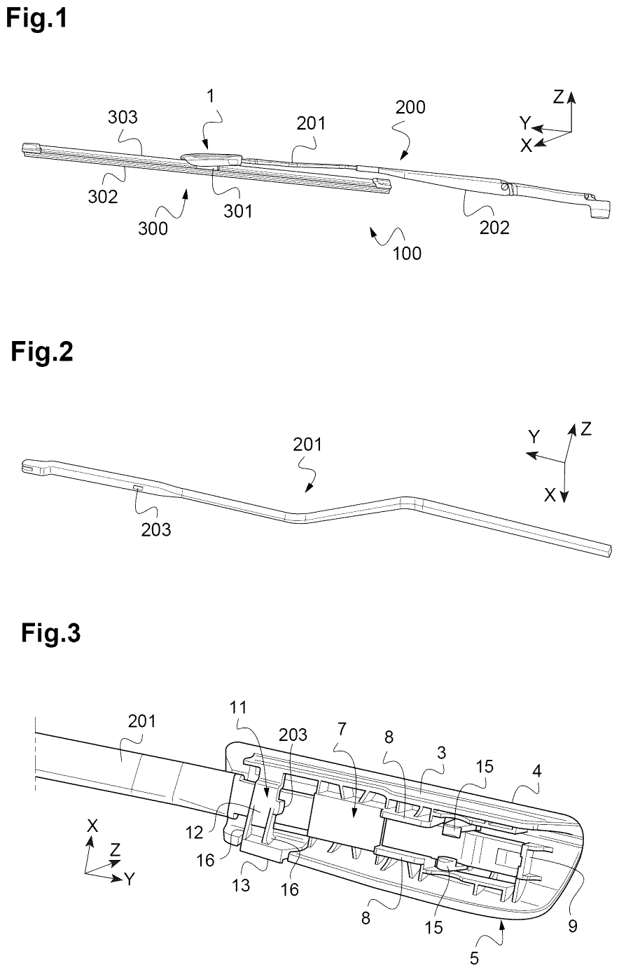

In the remainder of the description, the longitudinal direction, the vertical direction and the transverse direction indicated in particular in FIG. 1 by the trihedral frame of reference (X, Y, Z) that is fixed with respect to the adapter will be adopted in a nonlimiting manner. The longitudinal direction Y corresponds to the direction in which the arm is introduced into the adapter. The vertical direction Z and transverse direction X are perpendicular to the longitudinal direction Y and perpendicular to one another.

The “rear” of the adapter denotes the side via which the wiper arm enters when it is inserted into the arm housing of the adapter, and the “front” denotes the opposite side.

The terms “lower”, “bottom” denote the side of the adapter that is intended to be closest to the glazed surface, and the terms “upper”, “top” denote the opposite side.

FIG. 1 shows a wiper device 100 comprising a wiper arm 200 which is intended to be connected to a motorized wiper mechanism of a vehicle and the end of which is connected to a windshield wiper 300 by means of an adapter 1, in order to clean a glazed surface of the vehicle, for example a windshield.

The arm 200 is of the rod-arm type, it comprises a rod 201 connected to a base 202 of the arm 200, which is itself intended to be connected to the motorized mechanism. The rod 201 extends between an end connected to the base 202 and an end that cooperates with the adapter 1 for connection to the wiper 300. The term “rod” is understood to mean a solid element, the end of which extends in the longitudinal direction Y. The rod 201 is “flat”, meaning that it has two planar and mutually parallel faces (FIG. 2).

As can be seen more particularly in FIG. 3 to FIG. 7, the adapter 1 extends mainly along the longitudinal direction Y. It is made in one piece.

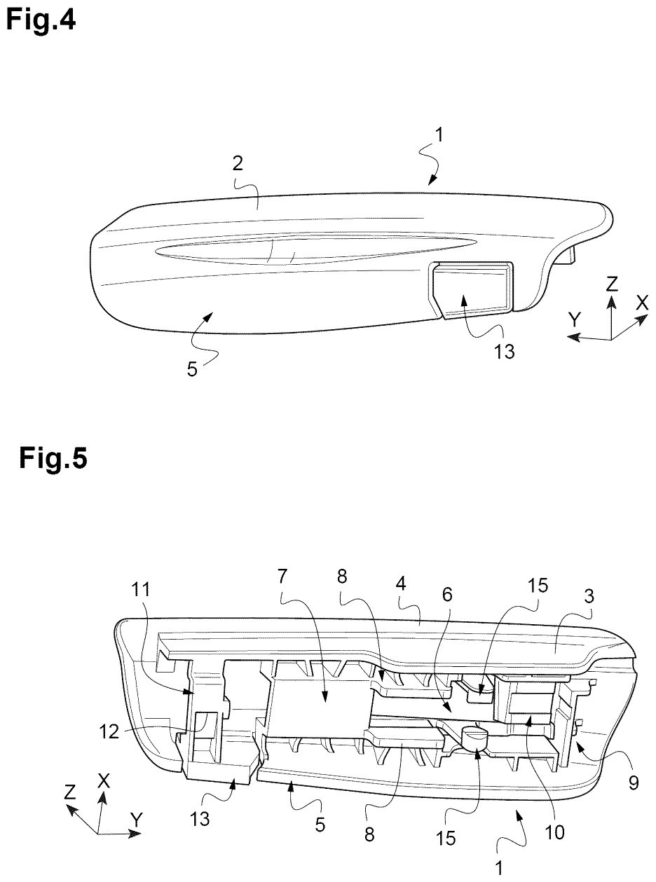

It comprises an upper wall 2 having, for example, a smooth and curved shape, this wall being visible when the wiper device 100 is fitted on a vehicle (FIG. 4).

At the back of this upper wall 2, the adapter 1 has a planar side wall 3 which extends in the longitudinal vertical plane (Z, Y). The upper surface 2 surmounts the side wall 3, extending laterally beyond it with an overhang 4 and optionally also at each longitudinal end (in this case at the rear end of the side wall 3, as can be seen in FIG. 5).

The upper surface 2 extends from the overhang 4 to a flank 5 of the adapter 1, on the opposite side to the side wall 3. The flank 5 of the upper surface 2 and the side wall 3 form opposite sides of the adapter 1.

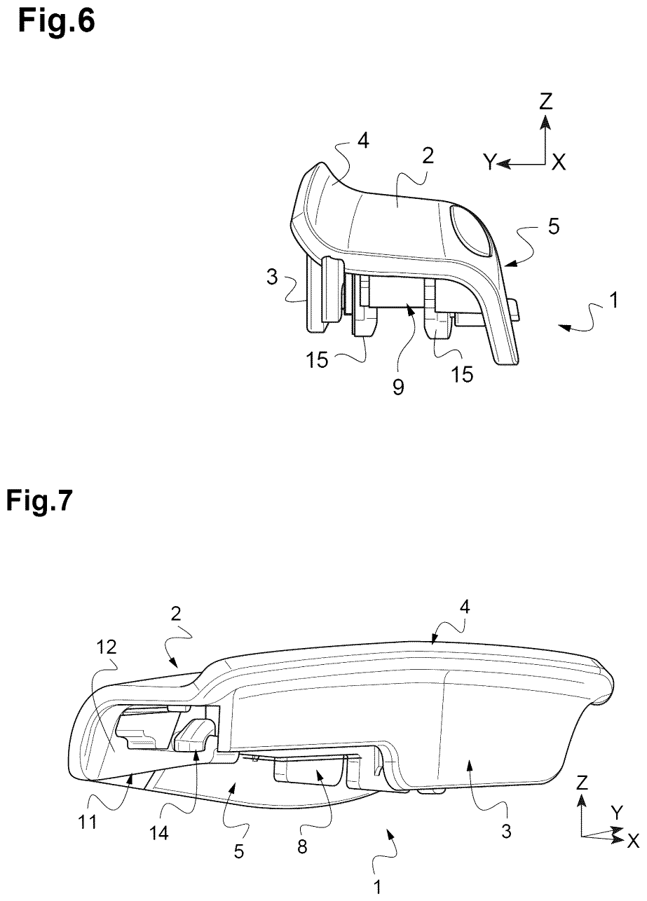

The upper surface 2 has a cross section that is, for example, substantially S-shaped, straightening upwardly from the overhang 4 to the flank 5 (FIG. 6). The upper surface 2 of the adapter 1 thus has an aerodynamic shape that tends to press it against the glazed surface to be wiped.

At the back of this upper wall 2, and as can be seen in FIG. 3 and FIG. 5, the adapter 1 also has elements that make it possible to lock the arm 200 to the windshield wiper 300 in an articulated manner.

To this end, the adapter 1 has an arm housing 6 that extends in the longitudinal direction Y, the arm housing 6 being configured to receive one end of the wiper arm 200, more specifically the rod 201 of the arm 200.

The arm housing 6 comprises, for example, a through-cage 7 for guiding and holding the rod 201, and two vertical walls 8 for guiding the sliding of the rod 201 in the longitudinal direction Y (FIG. 3). The vertical walls 8 extend from the upper wall 2 in the longitudinal vertical plane (Z, Y), are mutually parallel and are arranged in the longitudinal continuation of the through-cage 7.

The adapter 1 also comprises a longitudinal stop 9 in the bottom of the arm housing 6, said stop being formed, for example, by a transverse wall extending from the back of the upper wall 2, and the end of the rod 201 of the arm 200 coming to bear against said stop in order to prevent the insertion of the rod 201 in the longitudinal direction Y.

The adapter 1 may also comprise a boss 10 situated at the back of the upper wall 2, close to the longitudinal stop 9 (FIG. 5), having a shape complementary to a curvature of the end of the rod 201 and engaging with the end of the rod 201 when the latter is plugged into the arm housing 6.

The adapter 1 also comprises a locking device 11 (FIG. 3, FIG. 5 and FIG. 7) that can adopt a rest position in which it can prevent the removal of the arm 200 in the longitudinal direction Y, the locking device 11 being able to adopt an unlocking position in which it allows the longitudinal movement of the arm 200 in order, in particular, to allow it to be inserted and removed.

The locking device 11 is, for example, arranged at the rear of the arm housing 6 of the adapter 1.

The locking device 11 has a flexible tab 12 extending in the transverse direction X, one end of the flexible tab 12 being connected to the side wall 3 and the other end bearing an unlocking button 13 that is accessible from the side of the adapter 1. The flexible tab 12 may have, for example two, reinforcing brackets 16 arranged under the end connected to the unlocking button 13, between the end and the unlocking button 13.

The flexible tab 12 bears a locking lug 14, for example in its middle, which is configured to be inserted into a corresponding opening 203 in the rod 201 of the wiper arm 200 when the rod 201 is inserted in abutment in the adapter 1 so as to lock the longitudinal movement of the rod 201 and, in particular, the removal of the arm 200 in the rest position of the adapter 1.

The unlocking button 13 is formed, for example, by a cutout of the upper surface 2 in the flank 5, while being inscribed in the smooth and curved shape of the upper surface 2 (FIG. 4).

The flexible tab 12 can pivot, by elastic bending, about a longitudinal pivot axis, formed at the hinge linking the flexible tab 12 to the side wall 3, into an unlocking position for disengaging the locking lug 14 from the wiper arm 200.

The longitudinal pivot axis situated at the side wall 3, and the unlocking button 13 situated on the flank 5 on the opposite side to the side wall 3, allow the flexible tab 12 to exhibit sufficient pivoting travel. The flexible tab 12 may, for example, pivot through an angle greater than 20°, for example less than 45°, for instance 30°.

The flexible tab 12 may pivot into the unlocking position during the introduction of the arm 200 into the adapter 1. Provision may be made for the locking lug 14 to have a curved shape or ramp shape tending to cause the flexible tab 12 to pivot during the insertion of the arm 200 into the adapter 1. More specifically, the curved shape or ramp shape has a transverse thickness that increases in the direction in which the arm 200 is introduced into the arm housing 6, so as to cause the flexible tab 12 to gradually pivot into the unlocking position as the arm 200 is introduced.

The flexible tab 12 may, moreover, pivot into the unlocking position when the user presses the unlocking button 13 of the adapter 1, lowering it. This action causes the flexible tab 12 to pivot about the longitudinal pivot axis in order to disengage the locking lug 14 from the wiper arm 200 in order for it to be possible to remove the wiper arm 200 from the adapter 1.

The flexible tab 12 is returned into its initial rest position when it is no longer acted upon by the arm 200 or the user. When the arm 200 is plugged into the adapter 1, the locking lug 14 fits in the opening 203 formed in the wiper arm 200, thereby immobilizing the arm 200 in the longitudinal introduction direction.

To connect the adapter 1 to the wiper 300, the adapter 1 and the connector 301 of the windshield wiper 300 have complementary holding and rotating members. The rotation between the adapter 1 and the connector 301 is realized about the transverse axis.

According to one exemplary embodiment of the holding and rotating members, the adapter 1 comprises two cylindrical studs 15 that face one another and are configured to engage with respective circular orifices in the connector 301. The cylindrical studs 15 are formed, for example, at the end of parallel and opposite tongues that are connected to the back of the upper wall 2 of the adapter 1.

The tongues extend on either side of the arm housing 6, beyond the arm 200 when it is received in the housing 6, the bases of these tongues being able to form a guide for the sliding of the arm 200 as it is plugged into the housing 6 in the longitudinal direction Y.

The tongues may move apart to allow the elastic mounting (or clip-fastening) of the adapter 1 on the connector 301.

The adapter 1 may also comprise reinforcing walls that extend under the upper wall 2, in particular between the side wall 3 and the arm housing 6, for example between the side wall 3 and the through-cage 7 and the vertical walls 8, and/or between the flank 5 and the arm housing 6, for example between the flank 5 and the through-cage 7 and the vertical walls 8, and/or against the longitudinal stop 9, in order to reinforce the stiffness of the adapter 1.

In operation, the introduction of the arm 200 into the adapter 1 causes the flexible tab 12 to pivot, by elastic bending, about a longitudinal pivot axis. When the arm 200 comes into abutment against the longitudinal stop 9 of the arm housing 6, the flexible tab 12 is returned into its initial position engaging the locking lug 14 in the opening 203 in the arm 200, thereby immobilizing the arm 200 in the longitudinal introduction direction Y.

To disconnect the arm 200 from the wiper 300, the user presses the unlocking button 13 on the side of the adapter 1, lowering it. This action causes the flexible tab 12 to pivot about the longitudinal pivot axis, disengaging the locking lug 14 from the wiper arm 200 and making it possible to remove the wiper arm 200 from the adapter 1.

The adapter 1 is particularly suitable for connection to a wiper 300, the spoiler 303 of which has an aerodynamic shape that rises higher in the adapter 1 than the spoilers of prior art wipers, the actuation of the locking device 11 on the side of the adapter 1 making it compatible with these versions of spoilers and with a sufficient clearance. In addition, the locking device 11 is easy to produce and easy to actuate.

1. An adapter configured to be able to join a windshield wiper to a wiper arm, the adapter comprising:
a side wall and an upper surface that surmounts the side wall and extends as far as a flank of the adapter on the opposite side to the side wall,
an arm housing that extends in a longitudinal direction at the back of the upper surface and is configured to receive one end of the wiper arm,
a locking device that has a flexible tab bearing a locking lug configured to be inserted into a corresponding opening in the wiper arm in order to lock the longitudinal movement of said arm,
wherein the flexible tab extends in a transverse direction, one end of the flexible tab being connected to the lateral wall and the other end bearing an unlocking button that is accessible from an opposite side of the adapter to the side wall, the flexible tab being able to pivot about a longitudinal pivot axis in order to disengage the locking lug from the wiper arm.

2. The adapter as claimed in claim 1, wherein the end of the flexible tab is directly connected to the side wall and the other end of the flexible tab bearing the unlocking button is accessible from the flank of the adapter.

3. The adapter as claimed in claim 1, wherein the unlocking button is formed by a cutout of the upper surface in the flank.

4. The adapter as claimed in claim 1, wherein the flexible tab pivots, by elastic bending, about the longitudinal pivot axis, formed at a hinge linking the flexible tab to the side wall, into an unlocking position for disengaging the locking lug from the wiper arm.

5. The adapter as claimed in claim 1, wherein the flexible tab is configured to be able to pivot through an angle greater than 20°.

6. The adapter as claimed in one of the claim 1, wherein the flexible tab is configured to be able to pivot through an angle less than 45°.

7. The adapter as claimed in claim 1, wherein the flexible tab has reinforcing brackets arranged under the end connected to the unlocking button.

8. The adapter as claimed in one claim 1, wherein the locking lug borne by the flexible tab is situated between a portion of the side wall of the adapter from which the flexible tab extends and the unlocking button.

9. The adapter as claimed in claim 1, wherein the locking lug has a transverse thickness that increases in the direction in which the wiper arm is introduced into the arm housing, so as to cause the flexible tab to gradually pivot as said arm is introduced.

10. The adapter as claimed in one of the claim 1, wherein the locking device is arranged at the rear of the arm housing.

11. The adapter as claimed in claim 1, wherein the upper surface has a smooth and curved shape, a cross section of which is substantially S-shaped.

12. The adapter as claimed in claim 1, further comprising two cylindrical studs that face one another and are configured to engage with respective circular orifices connector of the windshield wiper, the cylindrical studs being formed at the end of parallel and opposite tongues that are connected to the back of the upper wall and extend on either side of the arm housing.

13. A wiper device comprising a wiper arm, a windshield wiper, and an adapter connecting the windshield wiper to the end of the wiper arm, with the adapter including a side wall and an upper surface that surmounts the side wall and extends as far as a flank of the adapter on the opposite side to the side wall, an arm housing that extends in a longitudinal direction at the back of the upper surface and is configured to receive one end of the wiper arm, a locking device that has a flexible tab bearing a locking lug configured to be inserted into a corresponding opening in the wiper arm in order to lock the longitudinal movement of said arm, wherein the flexible tab extends in a transverse direction, one end of the flexible tab being connected to the lateral wall and the other end bearing an unlocking button that is accessible from an opposite side of the adapter to the side wall, the flexible tab being able to pivot about a longitudinal pivot axis in order to disengage the locking lug from the wiper arm.
